(19) United States
(12) Patent Application Publication
(10) Pub. No.: US 2008/0019143 A1
(43) Pub. Date: Jan. 24, 2008

(54) LED advertise board

(76) Inventors: Andy Kaoh, Taipei Hsien (TW); Shieh-Hwei Lee Chen, Taipei Hsien (TW)

Correspondence Address: ANDY KAOH, 235 Chung - Ho, Box 8-24, Taipei, omitted

(21) Appl. No.: 11/489,951

(22) Filed: Jul. 20, 2006

(51) Int. Cl. B64D 47/06

(52) U.S. Cl. 362/559

(57) ABSTRACT

An LED advertise board for alerting people with flash LED lamps is disclosed. The LED advertise board comprises a box body; a substrate received in the box body; the substrate being installed at an interior of the box body; an upper side of the substrate having a lens which is embedded into a first groove of the box body; two sides of the substrate having respective LED lamps; the substrate being formed with a matrix LED lamp for displaying characters; one side of the substrate being installed with a power receptacle for being connected to a power supply; a network receptacle being formed aside the power receptacle for being connected to an external computer; each of the two sides of the box body having a lateral cover which is locked to the ring hook. In emergency, the LED lamps at two side flash to alert the user.

### FIELD OF THE INVENTION

The present invention relates to advertise boards, in particular to an LED advertise board, wherein in emergency, the LED lamps of the LED advertise board can flash to inform the user. The contents of the display board are changeable by a far end computer so that the information can be transferred to user real time. Furthermore, the present invention can be assembled transversally, or vertically by suspending or hanging to a wall so that the user can view the display board easily.

### BACKGROUND OF THE INVENTION

In the prior art, the advertise boards are used in commercial sings, hospitals, medical places, department stores, airports, police stations, fire bureaus, bars, etc. Generally, advertise boards display messages through a computer. Generally although the contents of the advertise board can be updated, the importance of the display messages cannot be emphasized. In emergency, referring to FIG. 1, if the advertise board 1 displays a sentence of “evacuation from No. 7 exit”. However it cannot take the attention of people. As a result, an optimum rescue time is lost.

Accordingly, the object of the present invention is to provides an LED Hi advertise board, wherein in emergency, the LED lamps of the LED advertise board flash to inform the user. The advertise board can be used in many various places, such as commercial sings, hospitals, medical places, department stores, airports, police stations, fire bureaus, bars, etc. The contents of the display board are changeable by a far end computer so that the information can be transferred to user real time. Furthermore, the present invention can be assembled transversally, vertically by suspending or hanging to a wall so that the user can view the display board easily. The LED lamps includes blue LEDs, red LEDs, and yellow LEDs for classifying the messages.

To achieve above object, the present invention provides an LED advertise board for alerting people with flash LED lamps, the LED advertise board comprising: a box body; a substrate received in the box body; the substrate being installed at an interior of the box body; an upper side of the substrate having a lens which is embedded into a first groove of the box body; two sides of the substrate having respective LED lamps; the substrate being formed with a matrix LED lamp for displaying characters; one side of the substrate being installed with a power receptacle for being connected to a power supply; a network receptacle being formed aside the power receptacle for being connected to an external computer; each of the two sides of the box body having a lateral cover which is locked to the ring hook. In emergency, the LED lamps at two side flash to alert the user.

The various objects and advantages of the present invention will be more readily understood from the following detailed description when read in conjunction with the appended drawing.

### BRIEF DESCRIPTION OF THE DRAWINGS

FIG. 1 shows the use of a prior art advertise board.

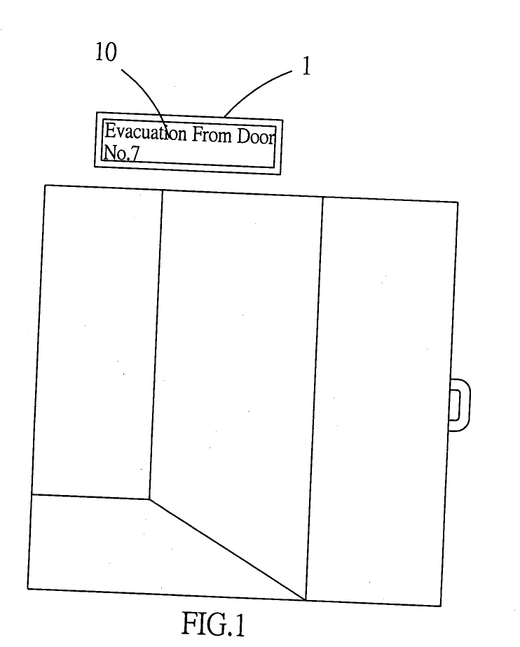

FIG. 2 is an exploded perspective view of the LED advertise board of the present invention.

FIG. 3 is an assembled exploded view of the LED advertise board of the present invention.

FIG. 4 shows the application of the LED advertise board of the present invention, which is hung and is connected with a network.

FIG. 5 shows the application of the present invention, where the present invention is used in rescue alert.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

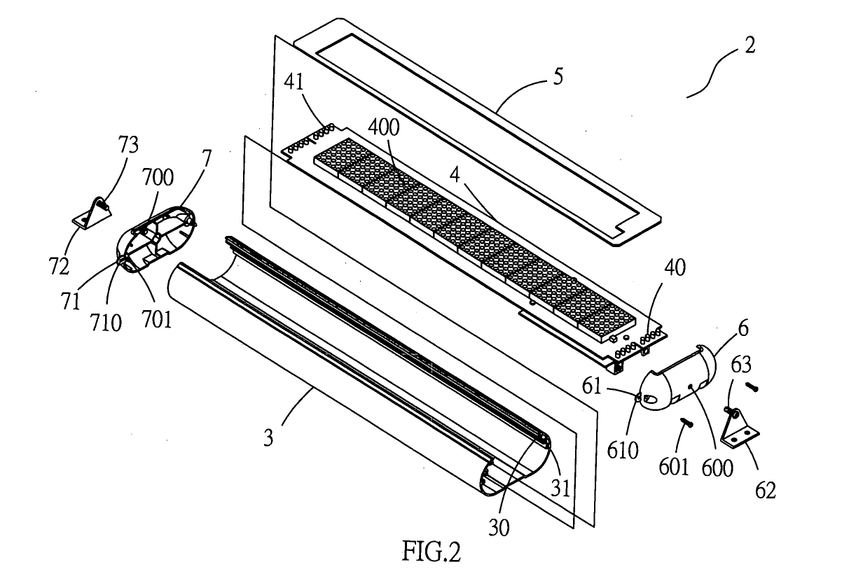

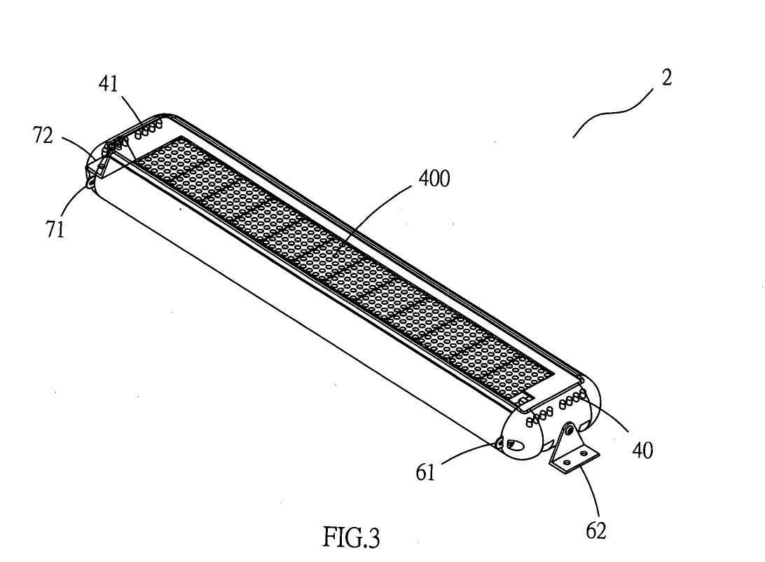

Referring to FIGS. 2 and 3, the display board 2 of the present invention includes a box body 3, ring hooks 61, 71, and seat sheets 62, 72.

Two sides of the substrate 4 have respective LED lamps 40, 41. The substrate 4 is formed with a matrix LED lamp 400 for displaying characters.

One side of the substrate 4 is installed with a power receptacle 42 for being connected to a power supply 420. A network receptacle 42 is formed aside the power receptacle 42 for being connected to an external computer 44. Thus the data in the display board 2 is changeable at far end.

The substrate 4 is installed at an interior of the box body 3. An upper side of the substrate 4 has a lens 5 which is embedded into a first groove 30 of the box body 3.

Each of the two sides of the box body 3 has a lateral cover 6, 7 which is locked to the ring hook 61, 71. Each ring hook 61, 71 has a via hole 610, 710 and thus the lateral cover 6, 7 can be locked to the ring hooks 61, 71 by screws 601, 701.

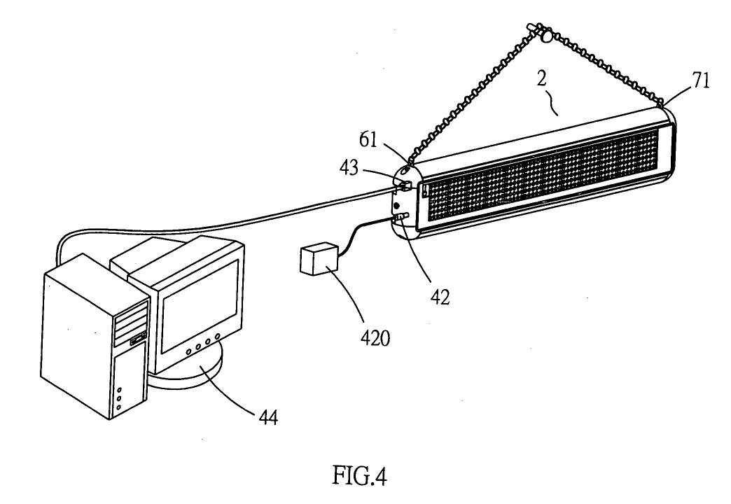

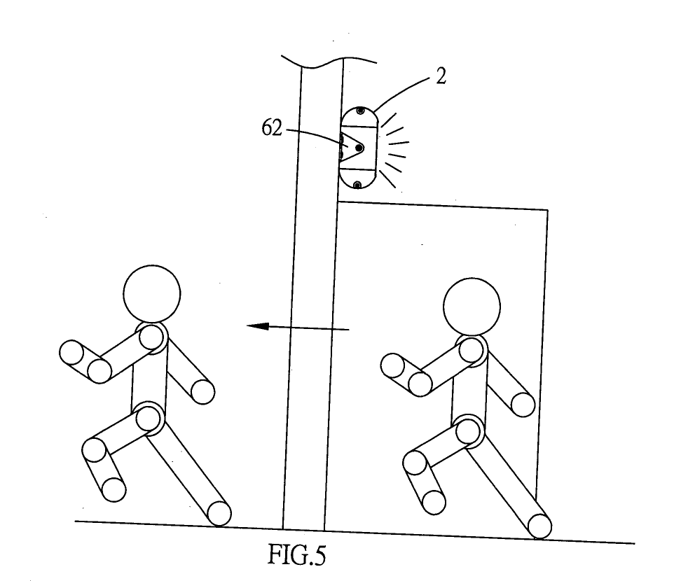

Two sides of the display board 2 have screw holes 600, 700 for fixing the seat sheets 62, 72, respectively by screwing the screws 63, 73 (referring to FIGS. 4 and 5).

In the present invention, the power receptacle 42 of the display board 2 receives a power supply 420 and the network receptacle 43 receives an external computer 44. The data in the display board 2 is changeable by a far end computer 44 real time.

In the present invention, the display board 2 can be arranged transversally, or vertically by suspending or hanging to a wall so that the user can view the display board 2 easily. For emergency, the LED lamps 40, 41 at two sides of the substrate 4 flashes to inform the user to take attention.

Furthermore, the present invention can be placed upon a table (not shown).

Advantages of the present invention will be described herein. In emergency, the LED lamps of the LED advertise board flash to inform the user. The contents of the display board 2 are changeable by a far end computer so that the information can be transferred to user real time. Furthermore, the present invention can be assembled transversally, or vertically by suspending or hanging to a wall so that the user can view the display board 2 easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An LED advertise board for alerting people with flash LED lamps, the LED advertise board comprising:
a box body;
a substrate received in the box body; the substrate being installed at an interior of the box body; an upper side of the substrate having a lens which is embedded into a first groove of the box body;
two sides of the substrate having respective LED lamps; the substrate being formed with a matrix LED lamp for displaying characters;
one side of the substrate being installed with a power receptacle for being connected to a power supply; a network receptacle being formed aside the power receptacle for being connected to an external computer;
each of the two sides of the box body having a lateral cover which is locked to the ring hook; and
wherein in emergency, the LED lamps at two sides flash to alert the user.

2. The LED advertise board as claimed in claim 1, wherein the LED lamps includes blue LEDs, red LEDs, and yellow LEDs for classifying the messages.

3. The LED advertise board as claimed in claim 1, wherein the two ring hooks serves that the LED advertise board can be suspended.

4. The LED advertise board as claimed in claim 1, wherein two sides of the display board are fixed with respective seat sheets by screwing screws to the screw holes at the lateral covers.
